(19) United States
(12) Patent Application Publication
(10) Pub. No.: US 2025/0280946 A1
(43) Pub. Date: Sep. 11, 2025

(54) ADAPTER ACCESSORY AND ELECTRONIC DEVICE CASE INCLUDING SAME

(71) Applicant: Samsung Electronics Co., Ltd., Suwon-si (KR)

(72) Inventors: Minhoo PARK, Suwon-si (KR); Junghyuck IM, Suwon-si (KR); Dohyung HA, Suwon-si (KR); Kijin KWON, Suwon-si (KR); Kisung KIM, Suwon-si (KR); Sangil PARK, Suwon-si (KR); Wooseok LEE, Suwon-si (KR); Gwangchae JUNG, Suwon-si (KR); Chongyoon CHUNG, Suwon-si (KR)

(21) Appl. No.: 19/217,271

(22) Filed: May 23, 2025

Related U.S. Application Data
(63) Continuation of application No. PCT/KR2023/016409, filed on Oct. 20, 2023.

(30) Foreign Application Priority Data
Nov. 29, 2022 (KR) 10-2022-0162476
Dec. 9, 2022 (KR) 10-2022-0171924

(51) Int. Cl. A45F 5/00; A45F 5/10; G06F 1/16

(52) U.S. Cl. CPC A45F 5/1516; A45F 5/10; G06F 1/1656

(57) ABSTRACT

example embodimentAn adapter accessory may include an accessory body including a coupling portion configured to couple an external accessory thereto, a deformable portion extending from the accessory body and configured to be at least partially deformable by a force applied from an outside, a button portion connected to the deformable portion and configured to press the deformable portion by the force applied from the outside or to be pressed by the deformable portion, and a fixing portion configured to be coupled to an external case and formed to protrude from at least a portion of the button portion. A material of the deformable portion may be the same as a material of the button portion. Various other embodiments may also be possible.

### CROSS-REFERENCE TO RELATED APPLICATIONS

This application is a continuation application of International Application No. PCT/KR2023/016409 designating the United States, filed on Oct. 20, 2023, in the Korean Intellectual Property Receiving Office and claiming priority to Korean Patent Application No. 10-2022-0162476, filed on Nov. 29, 2022, and Korean Patent Application No. 10-2022-0171924, filed on Dec. 9, 2022, the disclosures of which are all hereby incorporated by reference herein in their entireties.

### TECHNICAL FIELD

Certain example embodiments may relate to an adapter accessory and/or an electronic device case including the same.

### BACKGROUND ART

Recently, various types of electronic devices such as mobile phones, tablet personal computers (tablet PCs), MP3 players, portable multimedia players (PMPs), and e-books have been provided, allowing users to access various contents through these electronic devices. In addition to a wireless transmission and reception function, an electronic device is equipped with various functions such as a multimedia function such as photos, music, and video playback, and an entertainment function such as games. As mobile communication services have expanded into the multimedia service area, users have been able to use multimedia services as well as voice calls and short messages through electronic devices.

Electronic devices are made thin and light for portable purposes. Since such an electronic device is prone to damage due to external physical impact, it may be used with an external cover (or case) that covers the exterior of the electronic device. The external cover that covers the exterior of the electronic device may not only provide the function of protecting the electronic device, but also have the effect of evoking an aesthetic appeal to a user.

### SUMMARY

According to an example embodiment, an adapter accessory may include an accessory body including a coupling portion configured to couple an external accessory thereto, a deformable portion extending from the accessory body and configured to be at least partially deformable by a force applied from an outside, a button portion connected, directly or indirectly, to the deformable portion and configured to press the deformable portion by the force applied from the outside or to be pressed by the deformable portion, and a fixing portion configured to be coupled, directly or indirectly, to an external case and formed to protrude from at least a portion of the button portion. A material of the deformable portion may be the same as a material of the button portion.

According to an example embodiment, an adapter accessory may include an accessory body including a coupling portion configured to couple an external accessory thereto, a deformable portion extending from the accessory body and configured to be at least partially deformable by a force applied from an outside, a button portion connected, directly or indirectly, to the deformable portion and configured to press the deformable portion by the force applied from the outside or to be pressed by the deformable portion, and a fixing portion configured to be coupled, directly or indirectly, to an external case and formed to protrude from at least a portion of the button portion. The accessory body, the deformable portion, the button portion, and the fixing portion may be integrally formed.

### BRIEF DESCRIPTION OF DRAWINGS

FIG. 1 is a perspective view illustrating an adapter accessory and a case which are separated from each other according to an example embodiment.

FIG. 2 is a perspective view illustrating an adapter accessory and a case which are coupled to each other according to an example embodiment.

FIG. 3 is a perspective view illustrating an adapter accessory according to an example embodiment.

FIG. 4 is a perspective view illustrating an adapter accessory according to an example embodiment.

FIG. 5A is a cut-away perspective view illustrating an adapter accessory according to an example embodiment.

FIG. 5B is a cross-sectional view illustrating an adapter accessory coupled to a case according to an example embodiment.

FIG. 5C is a cross-sectional view illustrating an adapter accessory separated from a case according to an example embodiment.

FIG. 6A is a cut-away perspective view illustrating an adapter accessory according to an example embodiment.

FIG. 6B is a cross-sectional view illustrating an adapter accessory coupled to a case according to an example embodiment.

FIG. 6C is a cross-sectional view illustrating an adapter accessory separated from a case according to an example embodiment.

FIG. 7A is a cut-away perspective view illustrating an adapter accessory according to an example embodiment.

FIG. 7B is a cross-sectional perspective view illustrating a portion of an adapter accessory according to an example embodiment.

FIG. 7C is a cross-sectional view illustrating an adapter accessory coupled to a case according to an example embodiment.

FIG. 7D is a cross-sectional view illustrating an adapter accessory separated from a case according to an example embodiment.

FIG. 8A is a cut-away perspective view illustrating an adapter accessory according to an example embodiment.

FIG. 8B is a cross-sectional perspective view illustrating a portion of an adapter accessory according to an example embodiment.

FIG. 8C is a cross-sectional view illustrating an adapter accessory coupled to a case according to an example embodiment.

FIG. 8D is a cross-sectional view illustrating an adapter accessory separated from a case according to an example embodiment.

FIG. 9A is a cut-away perspective view illustrating an adapter accessory according to an example embodiment.

FIG. 9B is a cross-sectional perspective view illustrating a portion of an adapter accessory according to an example embodiment.

FIG. 9C is a cross-sectional view illustrating an adapter accessory coupled to a case according to an example embodiment.

FIG. 9D is a cross-sectional view illustrating an adapter accessory separated from a case according to an example embodiment.

FIG. 10A is a perspective view illustrating an adapter accessory according to an example embodiment.

FIG. 10B is a cross-sectional view illustrating an adapter accessory according to an example embodiment.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via at least a third element(s). Thus, for example, “connected” as used herein covers direct and indirect connections.

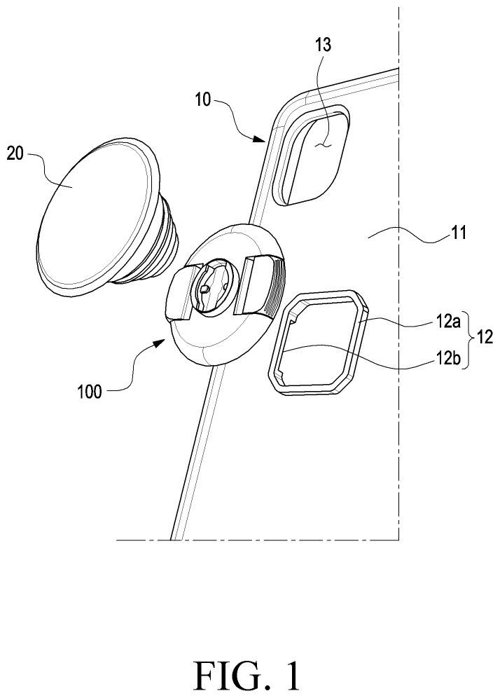

FIG. 1 is a perspective view illustrating an adapter accessory and a case which are separated from each other according to an example embodiment.

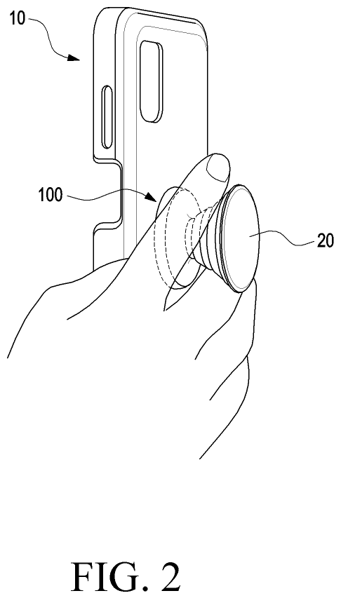

FIG. 2 is a perspective view illustrating an adapter accessory and a case which are coupled, directly or indirectly, to each other according to an example embodiment.

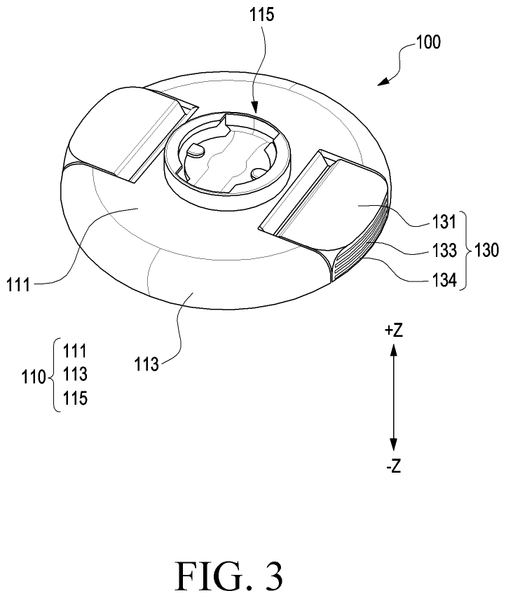

The embodiments of FIGS. 1 and 2 may be combined with the embodiments of FIGS. 3 to 10B.

Referring to FIGS. 1 and 2, an adapter accessory 100 may be detachably coupled, directly or indirectly, to a case 10 of an electronic device. In addition, an external accessory 20 may be detachably coupled to the adapter accessory 100.

According to an embodiment, the case 10 of the electronic device may include a cover portion 11 surrounding at least a portion of the electronic device. The cover portion 11 may protect the electronic device from external impact (e.g., external impact such as chemical or physical impact) and provide various colors and textures to the appearance of the electronic device, thereby providing an aesthetic appeal to a user. The case 10 of the electronic device may also be referred to as an external case.

Various types of electronic devices may be mounted on the case 10 (or the cover portion 11) of the electronic device. The electronic device may include at least one of, for example, a portable communication device (e.g., a smartphone), a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. According to an embodiment, the electronic device mounted on the cover portion 11 may include any electronic device that is generally small enough to be carried by a user and allows a camera to be disposed on a front surface, a rear surface, or both surfaces thereof.

According to an embodiment, the cover portion 11 may include a flat surface that covers at least a portion of the electronic device (e.g., the rear surface of the electronic device) and a plurality of side surfaces formed on edges of the flat surface. The plurality of side surfaces of the cover portion 11 may cover the side surfaces of the electronic device. The shape of the cover portion 11 illustrated in FIGS. 1 and 2 is exemplary, and may be subjected to various design modifications depending on the shape of the electronic device mounted on the case 10.

According to an embodiment, the case 10 may further include at least one opening 13 formed on at least a portion of the flat surface of the cover portion 11. The at least one opening 13 may accommodate a camera module (or camera deco member) of the electronic device, when the case 10 and the electronic device are coupled. The shape, position, or number of the at least one opening 13 in FIGS. 1 and 2 is exemplary, and may be provided in various shapes, positions, or numbers to accommodate the camera module or another exposed component of the electronic device.

According to an embodiment, the case 10 may further include a fastening portion 12 formed (or disposed) on the flat surface of the cover portion 11. At least a portion of the adapter accessory 100 may be accommodated in the fastening portion 12. Further, the adapter accessory 100 may be detachably fastened to the fastening portion 12.

According to an embodiment, the fastening portion 12 may include a protrusion 12a formed to protrude from the plane of the cover portion 11. The protrusion 12a may be formed in the form of a plurality of walls that are continuously connected to form a closed area. For example, the shape of the protrusion 12a may be an octagon as in the illustrated embodiment. However, the protrusion 12a is not limited thereto and may be formed in various polygonal shapes.

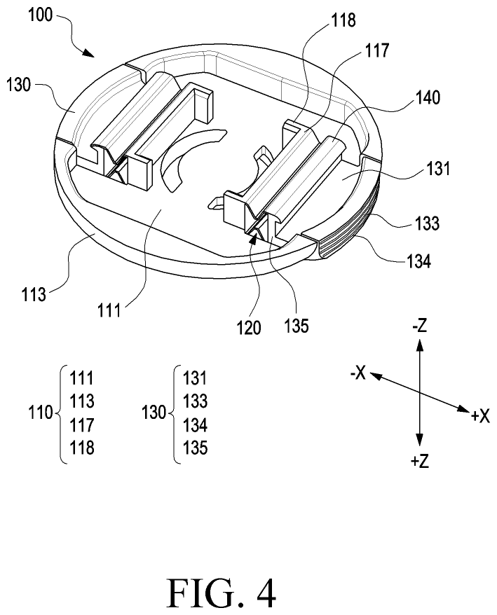

According to an embodiment, the fastening portion 12 may include at least one groove 12b formed to be recessed from at least a portion of the protrusion 12a. The at least one groove 12b may be formed on, directly or indirectly, each of a pair of inner walls of the protrusions 12a facing each other. A fixing portion (e.g., a fixing portion 140 of FIG. 4) of the adapter accessory 100 may be inserted into the fastening portion 12.

According to an embodiment, the adapter accessory 100 may be detachably coupled, directly or indirectly, to the fastening portion 12 of the case 10. For example, the adapter accessory 100 may be fixed to the fastening portion 12 of the case 10 or detached from the fastening portion 12 of the case 10. As described below, a user may easily couple the adapter accessory 100 to the case 10 or easily detach it from the case 10. Accordingly, the adapter accessory 100 may be compatible with various cases including the fastening portion 12. For example, as the single adapter accessory 100 is detachably coupled to each case including the fastening portion 12, the user may use the single adapter accessory 100 for various cases.

According to an embodiment, the external accessory 20 may be detachably coupled to a coupling portion (e.g., a coupling portion 115 of FIG. 3) of the adapter accessory 100. For example, the external accessory 20 may be fixed to the coupling portion 115 of the adapter accessory 100 or detached from the coupling portion of the adapter accessory 100. As described below, the user may easily couple the external accessory 20 to the adapter accessory 100 or easily detach it from the adapter accessory 100. Accordingly, the user may couple various types of external accessories to the single adapter accessory 100. For example, the user may couple various external accessories having a structure that may be coupled to the coupling portion of the adapter accessory 100 to the adapter accessory 100 and use them.

According to an exemplary embodiment, the illustrated external accessory 20 may be a scalable device (e.g., a pop-socket) that provides a grip function for the user to easily hold the electronic device or provides a stand function for the electronic device, to which the type of the external accessory 20 is not limited.

FIG. 3 is a perspective view illustrating an adapter accessory according to an example embodiment.

FIG. 4 is a perspective view illustrating the adapter accessory according to an example embodiment.

FIG. 4 is a perspective view illustrating the adapter accessory viewed from a different direction from in FIG. 3.

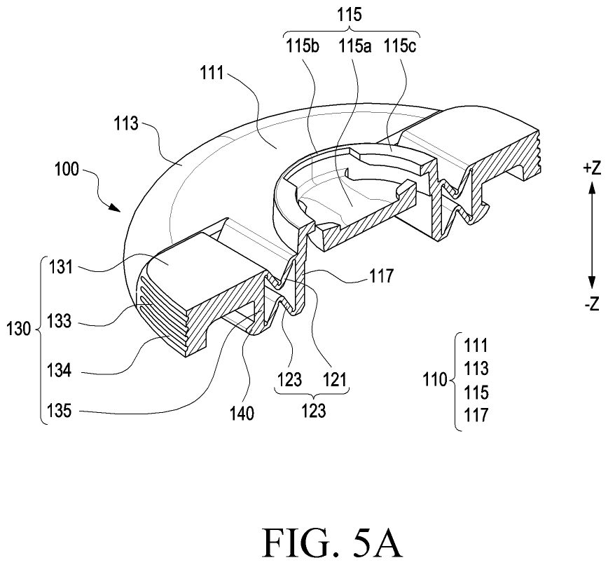

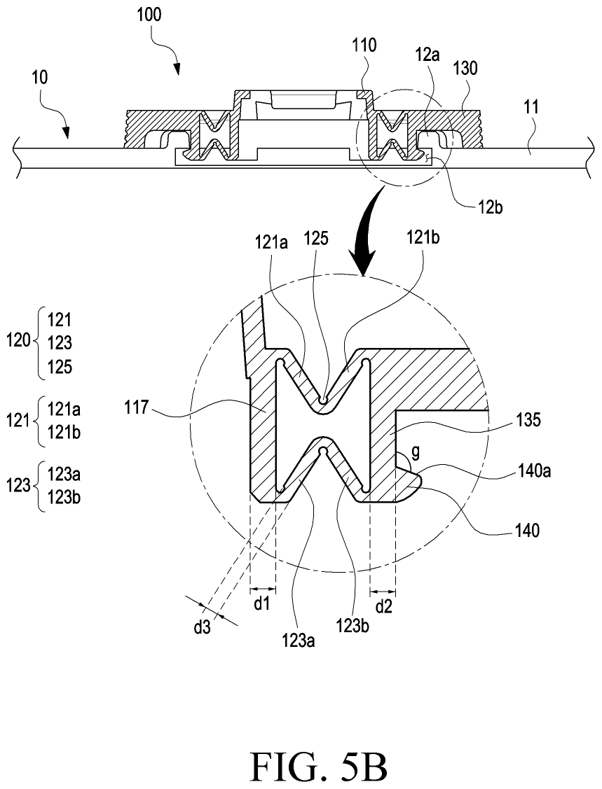

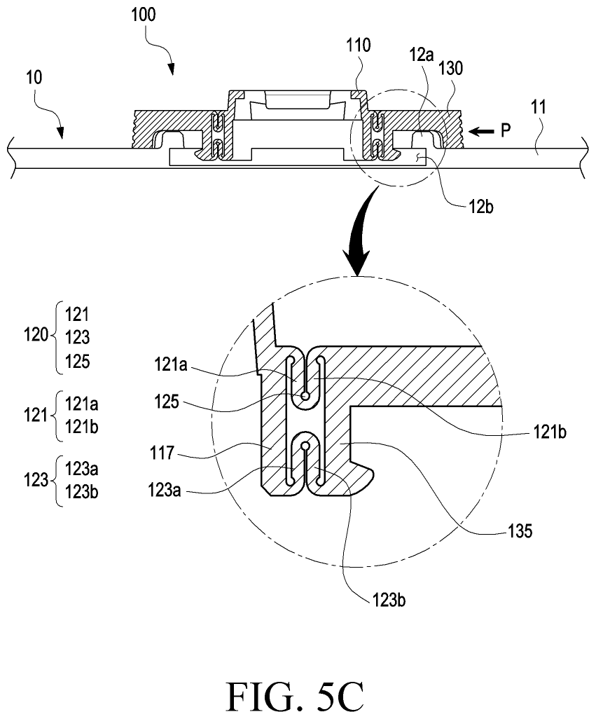

The embodiments of FIGS. 3 and 4 may be combined with the embodiments of FIGS. 1 and 2 or the embodiments of FIGS. 5A to 10B.

Referring to FIGS. 3 and 4, the adapter accessory 100 (e.g., the adapter accessory 100 of FIGS. 1 and 2) may include an accessory body 110, a deformable portion 120, a button portion 130, or the fixing portion 140.

According to an embodiment, the accessory body 110 may be configured to cover at least a portion of a cover portion (e.g., the cover portion 11 of FIGS. 1 and 2) of a case (e.g., the case 10 of FIGS. 1 and 2) of an electronic device. The accessory body 110 may form, for example, a body of the adapter accessory 100. The accessory body 110 may also be referred to as a housing, a body portion, or a cover portion.

According to an embodiment, the accessory body 110 may be formed in a circular shape as a whole. However, the accessory body 110 is not limited thereto, and may be formed in various shapes.

According to an embodiment, the accessory body 110 may include a first flat portion 111, a first side portion 113, the coupling portion 115, a first support wall 117, or a third support wall 118.

According to an embodiment, when the adapter accessory 100 is coupled to the case, the first flat portion 111 may face the cover portion (e.g., the cover portion 11 of FIGS. 1 and 2) of the case.

According to an embodiment, the first flat portion 111 may be formed in, but is not limited to, a circular shape. The first flat portion 111 may have a first surface (e.g., a surface facing a +Z direction in FIGS. 3 and 4) facing a first direction (e.g., the +Z direction in FIGS. 3 and 4) and a second surface (e.g., a surface facing a-Z direction in FIGS. 3 and 4) facing in a direction (e.g., the −Z direction in FIGS. 3 and 4) opposite to the first direction.

According to an embodiment, the first surface of the first flat portion 111 may be interpreted as a surface facing outward, when the adapter accessory 100 is coupled to the case. Further, the second surface of the first flat portion 111 may be interpreted as a surface facing the case, when the adapter accessory 100 is coupled to the case.

According to an embodiment, the first side portion 113 may be interpreted as a portion that is disposed along the edge of the first flat portion 111 and extends from the edge of the first flat portion 111 toward the case (e.g., the case 10 of FIGS. 1 and 2). For example, the first side portion 113 may be disposed to surround a fastening portion (e.g., the fastening portion 12 of FIG. 1) of the case, when the adapter accessory 100 is coupled to the case.

According to an embodiment, the first side portion 113 may extend from the edge of the first flat portion 111 in the second direction (e.g., the −Z direction of FIGS. 3 and 4).

According to an embodiment, a portion where the first side portion 113 and the first flat portion 111 are connected may be formed to be curved, which should not be construed as limiting.

According to an embodiment, the coupling portion 115 may be formed on, directly or indirectly, the first surface of the first flat portion 111. The coupling portion 115 may provide a space for coupling an external accessory (e.g., the external accessory 20 of FIGS. 1 and 2) thereto. A detailed description of the coupling portion 115 will be described later.

According to an embodiment, the first support wall 117 and the third support wall 118 may be formed on, directly or indirectly, the second surface of the first flat portion 111. The first support wall 117 may be configured to support at least a portion of the deformable portion 120. The first support wall 117 may be formed to protrude from the second surface of the first flat portion 111 in the second direction (e.g., the −Z direction in FIGS. 3 and 4). The first support wall 117 may be formed to extend in one direction.

According to an embodiment, the first support wall 117 may be disposed inside the first side portion 113.

According to an embodiment, the third support wall 118 may extend from both ends of the first support wall 117. For example, the third support wall 118 may extend from both ends of the first support wall 117 in an opposite direction to the deformable portion 120. The third support wall 118 may support the first support wall 117, so that the first support wall 117 is not bent when the deformable portion 120 is compressively deformed or restoratively deformed.

According to an embodiment, the first support wall 117 and the third support wall 118 may be disposed in an inner region formed by the first side portion 113.

According to an embodiment, the deformable portion 120 may extend from the accessory body 110. The deformable portion 120 may be configured to be at least partially deformable by a force applied from the outside.

According to an embodiment, the deformable portion 120 may extend from the first support wall 117 of the accessory body 110. For example, the deformable portion 120 may extend from the first support wall 117 toward the outside of the accessory body 110 (e.g., an X-axis direction in FIG. 4).

According to an embodiment, when the user presses the button portion 130, the deformable portion 120 may be compressed by a force provided by the user, and when the user releases the pressure on the button portion 130, the deformable portion 120 may be restored by an elastic restoring force.

According to an embodiment, the button portion 130 may be connected, directly or indirectly, to the deformable portion 120. The button portion 130 may be configured to press the deformable portion 120 by an external force or to be pressed by an elastic restoring force of the deformable portion 120.

According to an embodiment, when the user presses the button portion 130, the button portion 130 may slide and compress the deformable portion 120, and when the user releases the pressure on the button portion 130, the button portion 130 may be pressed by the deformable portion 120 and slide. For example, when the user applies an external force to a pair of button portions 130, deformable portions 120 may be compressed, and when the user releases the external force to the pair of button portions 130, the deformable portions 120 may be restored.

According to an embodiment, the button portion 130 may include a second flat portion 131, a second side portion 133, a pattern portion 134, or a second support wall 135.

According to an embodiment, the button portion 130 may be disposed in a groove formed on at least one portion of a side surface of the accessory body 110.

According to an embodiment, the second flat portion 131 of the button portion 130 may be disposed on substantially the same plane as the first flat portion 111 of the accessory body 110.

According to an embodiment, the second side portion 133 may extend from an outer edge of the first flat portion 131 toward the cover portion of the case (e.g., the case 10 of FIGS. 1 and 2). According to an embodiment, the second side portion 133 may be connected, directly or indirectly, to the edge of the first flat portion 131 so as to be angled.

According to an embodiment, the second side portion 133 may be formed with the pattern portion 134 including a plurality of patterns sunken from a surface of the second side portion 133. The pattern portion 134 may be formed with a plurality of slit structures so that the second side portion 133 may have a rough surface. Accordingly, when the user presses the second side portion 133 of the button portion 130, slipping of the user's hand may be prevented or reduced.

According to an embodiment, the second support wall 135 may extend from an inner edge of the second flat portion 131 toward the cover portion of the case. In an embodiment, the second support wall 135 may face the first support wall 117 with the deformable portion 120 interposed therebetween.

In an embodiment, when the user presses the button portion 130, the second support wall 135 may press the deformable portion 120, and when the user releases the pressure on the button portion 130, the second support wall 135 may be pressed by the deformable portion 120.

In an embodiment, at least a portion of the deformable portion 120 may be connected, directly or indirectly, to the second support wall 135.

In an embodiment, the fixing portion 140 may extend from one end (e.g., an end facing the −Z direction in FIG. 4) of the second support wall 135 toward the outside of the accessory body 110. The fixing portion 140 may be interpreted as a portion of the button portion 130.

According to an embodiment, the fixing portion 140 may be configured to be inserted into or removed from at least one groove (e.g., the at least one groove 12b of FIG. 1) of the case (e.g., the case 10 of FIG. 1).

According to an embodiment, the adapter accessory 100 may be formed of a non-metallic material (e.g., polycarbonate). Further, the deformable portion 120, the button portion 130, or the fixing portion 140 of the adapter accessory 100 may be formed integrally.

According to an embodiment, the accessory body 110, the deformable portion 120, the button portion 130, or the fixing portion 140 of the adapter accessory 100 may be formed of substantially the same material. For example, the accessory body 110, the deformable portion 120, the button portion 130, or the fixing portion 140 may be formed of a non-metallic material (e.g., polycarbonate).

According to an embodiment, the accessory body 110, the deformable portion 120, the button portion 130, or the fixing portion 140 of the adapter accessory 100 may include a different material (e.g., a metal material).

According to an embodiment, a pair of button portions 130 may be provided. For example, the pair of button portions 130 may be disposed to face each other. According to an embodiment, a pair of deformable portions 120, a pair of first support walls 117, and a pair of third support walls 118 may be provided to correspond to the pair of button portions 130 in the adapter accessory 100.

FIG. 5A is a cut-away perspective view illustrating an adapter accessory according to an example embodiment.

FIG. 5B is a cross-sectional view illustrating an adapter accessory coupled to a case according to an example embodiment.

FIG. 5C is a cross-sectional view illustrating an adapter accessory separated from a case according to an example embodiment.

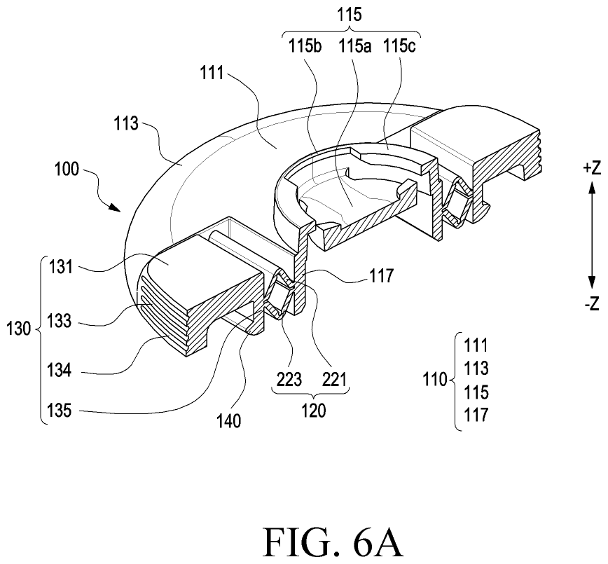

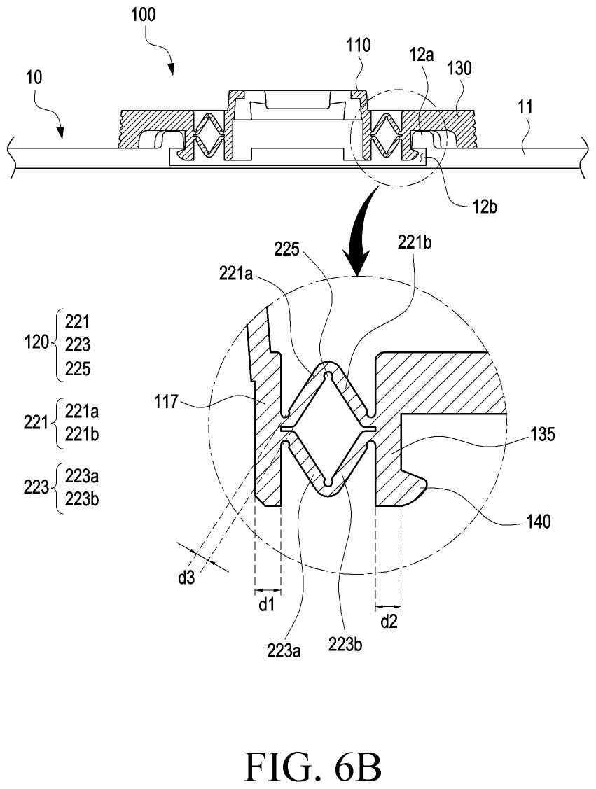

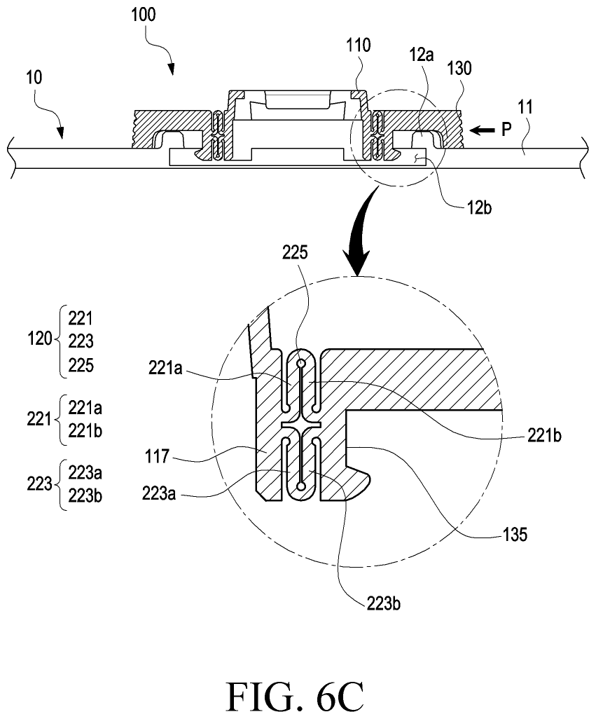

The embodiments of FIGS. 5A to 5C may be combined with the embodiments of FIGS. 1 to 4 or the embodiments of FIGS. 6A to 10B.

According to an embodiment, the coupling portion 115 may include a bottom portion 115a, a protruding portion 115b, and a loop portion 115c.

According to an embodiment, the bottom portion 115a may form substantially the same plane as the first flat portion 111. For example, the bottom portion 115a may be interpreted as a portion of the first flat portion 111.

According to an embodiment, the protruding portion 115b may be formed in a substantially circular shape, and may be a portion protruding in the first direction (e.g., the +Z direction in FIG. 5A) from the first flat portion 111 or the bottom portion 115a.

According to an embodiment, the loop portion 115c may be a portion that extends inward from a top end (e.g., an end facing the +Z direction in FIG. 5A) of the protruding portion 115b. The loop portion 115c may be formed only on a portion of the protruding portion 115b, not on the remaining portion of the protruding portion 115b.

According to an embodiment, a fixing portion of the external accessory (e.g., the external accessory 20 of FIGS. 1 and 2) may be inserted into the inside of the protruding portion 115b through the portion where the loop portion 115c is not formed. Then, when the external accessory is rotated, the fixing portion of the external accessory is disposed between the loop portion 115c and the bottom portion 115a, thereby preventing or reducing chances of the external accessory from being separated from the coupling portion 115.

According to an embodiment, the deformable portion 120 of the adapter accessory 100 may include a first deformable part 121 or a second deformable part 123.

According to an embodiment, the first deformable part 121 may connect a top end (e.g., an end facing the +Z direction in FIG. 5A) of the first support wall 117 and a top end (e.g., an end facing the +Z direction in FIG. 5A) of the second support wall 135.

According to an embodiment, the second deformable part 123 may connect a bottom end (e.g., an end facing the −Z direction in FIG. 5A) of the first support wall 117 and a bottom end (e.g., an end facing the −Z direction in FIG. 5A) of the second support wall 135.

According to an embodiment, each of the first deformable part 121 and the second deformable part 123 may be formed to be at least partially bendable.

According to an embodiment, the first deformable part 121 may include a first inclined part 121a and a second inclined part 121b. The first inclined part 121a may extend from the top end of the first support wall 117. Further, the first inclined part 121a may be inclined from the first support wall 117 to form an acute angle with respect to the first support wall 117. For example, the first inclined part 121a may be interpreted as extending from the top end of the first support wall 117 toward the bottom end of the second support wall 135.

According to an embodiment, the first inclined part 121a may be connected, directly or indirectly, to the second inclined part 121b.

The second inclined part 121b may extend from the top end of the second support wall 135. Further, the second inclined part 121b may be inclined from the second support wall 135 to form an acute angle with respect to the second support wall 135. For example, the second inclined part 121b may be interpreted as extending from the top end of the second support wall 135 toward the bottom end of the first support wall 117.

According to an embodiment, the second inclined part 121b may be connected, directly or indirectly, to the first inclined part 121a.

According to an embodiment, the first inclined part 121a and the second inclined part 121b may be connected in a ‘V’ shape, and the vertex of the ‘V’ shape may be disposed to face the second deformable part 123.

According to an embodiment, the second deformable part 123 may include a third inclined part 123a and a fourth inclined part 123b. The third inclined part 123a may extend from the bottom end of the first support wall 117. Further, the third inclined part 123a may be inclined from the first support wall 117 to form an acute angle with respect to the first support wall 117. For example, the third inclined part 123a may be interpreted as extending from the bottom end of the first support wall 117 toward the top end of the second support wall 135.

According to an embodiment, the third inclined part 123a may be connected, directly or indirectly, to the fourth inclined part 123b.

The fourth inclined part 123b may extend from the bottom end of the second support wall 135. Further, the fourth inclined part 123b may be inclined from the second support wall 135 to form an acute angle with respect to the second support wall 135. For example, the fourth inclined part 123b may be interpreted as extending from the bottom end of the second support wall 135 toward the top end of the first support wall 117.

According to an embodiment, the fourth inclined part 123b may be connected, directly or indirectly, to the third inclined part 123a.

According to an embodiment, the third inclined part 123a and the fourth inclined part 123b may be connected in a ‘V’ shape, and the vertex of the ‘V’ shape may be disposed to face the first deformable part 121.

Referring to FIG. 5B, a pair of fixing portions 140 of the adapter accessory 100 may be inserted into the at least one groove 12b of the case 10 of the electronic device.

Accordingly, since the pair of fixed portions 140 are fixedly caught in at least a portion of the protrusion 12a of the case 10, the adapter accessory 100 may be prevented, or chances reduced, from being separated from the case 10.

Referring to FIG. 5C, the deformable portion 120 is shown as compressed. For example, when the user presses the button portion 130 (e.g., the second side portion 135) (e.g., applies a force in a direction P), the deformable portion 120 may be compressed by the button portion 130, while at least a portion of the deformable portion 120 is bent. When the deformable portion 120 is compressed, the first support wall 117 and the second support wall 135 may come closer.

According to an embodiment, when the deformable portion 120 is compressed, the fixing portion 140 connected to the button portion 130 may be separated from the at least one groove 12b. As illustrated in FIG. 5C, with the fixing portion 140 detached from the at least one groove 12b, the adapter accessory 100 may be separated from the case 10.

In order to couple the adapter accessory 100 to the case 10, the deformable portion 120 may be compressed by pressing the button portion 130, and then the adapter accessory 100 may be seated on the fastening portion 12 of the case 10. Further, with the adapter accessory 100 seated on the fastening portion 12, when the pressure on the button portion 130 is released, the deformable portion 120 may be elastically restored, so that the fixing portion 140 may be inserted into the at least one groove 12b, as illustrated in FIG. 5B.

According to an embodiment, the first inclined part 121a, the second inclined part 121b, the third inclined part 123a, and the fourth inclined part 123b may have substantially the same thickness d3.

According to an embodiment, the thickness d3 of the first inclined part 121a, the second inclined part 121b, the third inclined part 123a, and the fourth inclined part 123b may be smaller than the thickness d1 of the first support wall 117. In addition, the thickness d3 of the first inclined part 121a, the second inclined part 121b, the third inclined part 123a, and the fourth inclined part 123b may be smaller than the thickness d2 of the second support wall 135. Accordingly, when the deformable portion 120 is compressed or elastically restored, the bending of the first support wall 117 or the second support wall 135 may be prevented or reduced.

According to an embodiment, the deformable portion 120 may include at least one recess 125. When each of the components of the deformable portion 120 is folded or unfolded relative to another component, the at least one recess 125 may prevent or reduce a chance of a portion connected to the other component from being torn. For example, the at least one recess 125 may be defined as a circular recess structure or a circular pivot structure.

According to an embodiment, the at least one recess 125 may be formed to be sunken further in at least a portion of the first deformable part 121 or at least a portion of the second deformable part 123 than in the other portion thereof.

According to an embodiment, the fixing portion 140 may include an inclined surface 140a to form a first angle g with respect to the second support wall 135. The first angle g may be an obtuse angle. For example, the first angle g may be an angle greater than about 90 degrees and less than about 135 degrees. According to an embodiment, since the inclined surface 140a of the fixing portion 140 is formed at the obtuse first angle g, even if the button portion 130 is twisted within a predetermined range when the user presses the button portion 130, the fixing portion 140 may be easily inserted into the at least one groove 12b.

FIG. 6A is a cut-away perspective view illustrating an adapter accessory according to an example embodiment.

FIG. 6B is a cross-sectional view illustrating an adapter accessory coupled to a case according to an example embodiment.

FIG. 6C is a cross-sectional view illustrating an adapter accessory separated from a case according to an example embodiment.

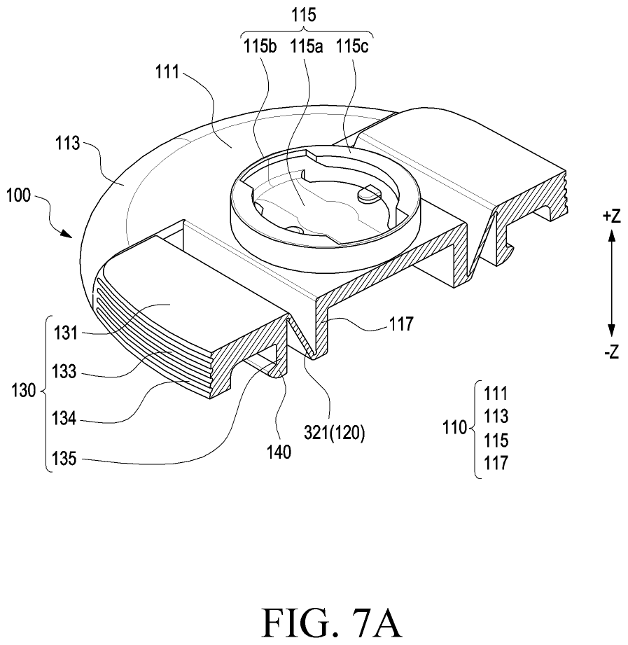

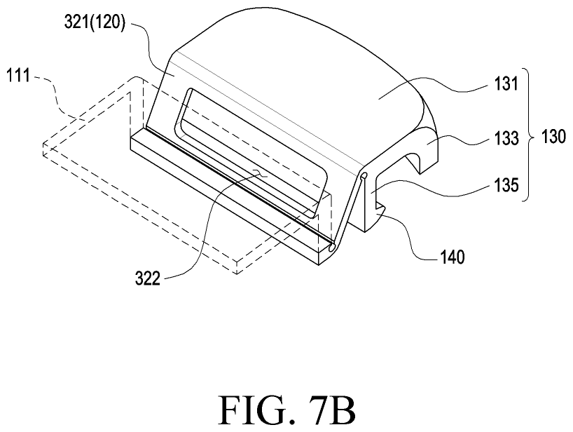

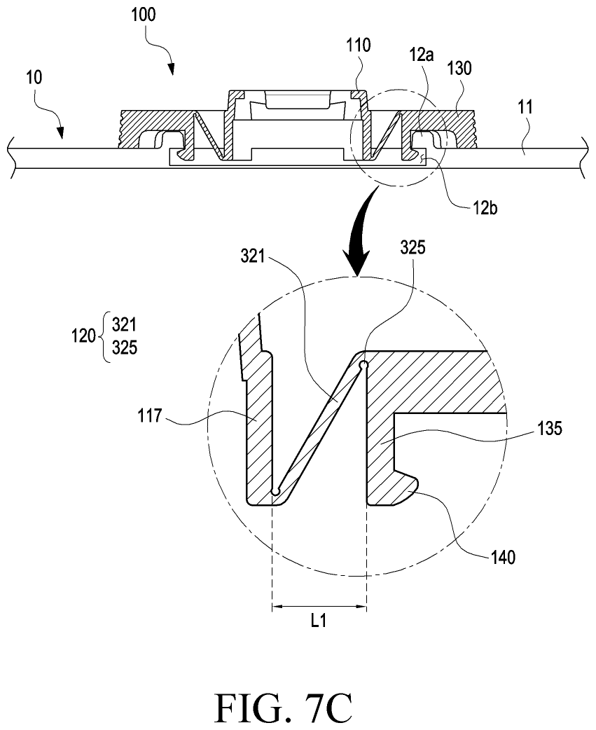

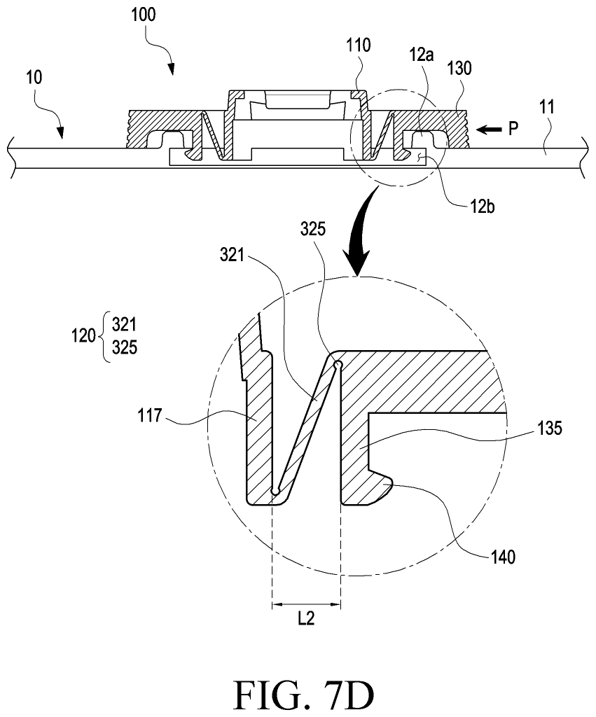

The embodiments of FIGS. 6A to 6C may be combined with the embodiments of FIGS. 1 to 5C or the embodiments of FIGS. 7A to 10B.

According to an embodiment, the deformable portion 120 of the adapter accessory 100 may include a first deformable part 221 or a second deformable part 223.

According to an embodiment, the first deformable part 221 may connect the top end (e.g., an end facing the +Z direction in FIG. 6A) of the first support wall 117 and the top end (e.g., an end facing the +Z direction in FIG. 6A) of the second support wall 135.

According to an embodiment, the second deformable part 223 may connect the bottom end (e.g., an end facing the −Z direction in FIG. 6A) of the first support wall 117 and the bottom end (e.g., an end facing the −Z direction in FIG. 6A) of the second support wall 135.

According to an embodiment, each of the first deformable part 221 and the second deformable part 223 may be formed to be at least partially bendable.

According to an embodiment, the first deformable part 221 may include a first inclined part 221a and a second inclined part 221b. The first inclined part 221a may extend from a portion of the first support wall 117. For example, the first inclined part 221a may be connected to a point between the top end (e.g., the end facing the +Z direction in FIG. 6A) and the bottom end (e.g., the end facing the −Z direction in FIG. 6A) of the first support wall 117. Further, the first inclined part 221a may be inclined from the first support wall 117 to form an acute angle with respect to the first support wall 117. For example, the first inclined part 221a may be interpreted as extending from a point of the first support wall 117 toward the top end of the second support wall 135.

According to an embodiment, the first inclined part 221a may be connected to the second inclined part 221b.

The second inclined part 221b may extend from a portion of the second support wall 135. For example, the second inclined part 221b may be connected to a point between the top end (e.g., an end facing the +Z direction in FIG. 6A) and the bottom end (e.g., an end facing the −Z direction in FIG. 6A) of the second support wall 135. Further, the second inclined part 221b may be inclined from the second support wall 135 to form an acute angle with respect to the second support wall 135. For example, the second inclined part 221b may be interpreted as extending from a point of the second support wall 135 toward the top end of the first support wall 117.

According to an embodiment, the second inclined part 221b may be connected to the first inclined part 221a.

According to an embodiment, the first inclined part 221a and the second inclined part 221b may be connected in a ‘V’ shape, and the vertex of the ‘V’ shape of the first inclined part 221a and the second inclined part 221b may face in an opposite direction to the vertex of a ‘V’ shape of a third inclined part 223a and a fourth inclined part 223b.

According to an embodiment, the second deformable part 223 may include the third inclined part 223a and the fourth inclined part 223b. The third inclined part 223a may extend from a portion of the first support wall 117. For example, the third inclined part 223a may be connected to a point between the top end (e.g., the end facing the +Z direction in FIG. 6A) and the bottom end (e.g., the end facing the −Z direction in FIG. 6A) of the first support wall 117. Further, the third inclined part 223a may be inclined from the first support wall 117 to form an acute angle with respect to the first support wall 117. For example, the third inclined part 223a may be interpreted as extending from a point of the first support wall 117 toward the bottom end of the second support wall 135.

According to an embodiment, the third inclined part 223a may be connected to the fourth inclined part 223b.

The fourth inclined part 223b may extend from a portion of the second support wall 135. For example, the fourth inclined part 223b may be connected to a point between the top end (e.g., the end facing the +Z direction in FIG. 6A) and the bottom end (e.g., the end facing the −Z direction in FIG. 6A) of the second support wall 135. Further, the fourth inclined part 223b may be inclined from the second support wall 135 to form an acute angle with respect to the second support wall 117. For example, the fourth inclined part 223b may be interpreted as extending from a point of the second support wall 135 toward the bottom end of the first support wall 117.

According to an embodiment, the fourth inclined part 223b may be connected to the third inclined part 223a.

According to an embodiment, the third inclined part 223a and the fourth inclined part 223b may be connected in the ‘V’ shape, and the vertex of the ‘V’ shape of the third inclined part 223a and the fourth inclined part 223b may face in an opposite direction to the vertex of the ‘V’ shape of the first inclined part 221a and the second inclined part 221b.

Referring to FIG. 6B, a pair of fixing portions 140 of the adapter accessory 100 may be inserted into the at least one groove 12b of the case 10 of the electronic device. Accordingly, as the pair of fixing portions 140 are fixedly caught in at least a portion of the protrusion 12a of the case 10, the adapter accessory 100 may be prevented or reduced from being separated from the case 10.

Referring to FIG. 6C, the deformable portion 120 is shown as compressed. For example, when the user presses the button portion 130 (e.g., the second side portion 135) (e.g., applies a force in the direction P), the deformable portion 120 may be compressed by the button portion 130, while at least a portion of the deformable portion 120 is bent. When the deformable portion 120 is compressed, the first support wall 117 and the second support wall 135 may come closer.

According to an embodiment, when the deformable portion 120 is compressed, the fixing portion 140 connected to the button portion 130 may be separated from the at least one groove 12b. As illustrated in FIG. 6C, with the fixing portion 140 detached from the at least one groove 12b, the adapter accessory 100 may be separated from the case 10.

In order to couple the adapter accessory 100 to the case 10, the deformable portion 120 may be compressed by pressing the button portion 130, and then the adapter accessory 100 may be seated on the fastening portion 12 of the case 10. Further, when the button portion 130 is released with the adapter accessory 100 seated on the fastening portion 12, the deformable portion 120 may be elastically restored, and thus the fixing portion 140 may be inserted into the at least one groove 12b, as illustrated in FIG. 6B.

According to an embodiment, the first inclined part 221a, the second inclined part 221b, the third inclined part 223a, and the fourth inclined part 223b may have substantially the same thickness d3.

According to an embodiment, the thickness d3 of the first inclined part 221a, the second inclined part 221b, the third inclined part 223a, and the fourth inclined part 223b may be smaller than the thickness d1 of the first support wall 117. Further, the thickness d3 of the first inclined part 221a, the second inclined part 221b, the third inclined part 223a, and the fourth inclined part 223b may be smaller than the thickness d2 of the second support wall 135. Accordingly, when the deformable portion 120 is compressed or elastically restored, the bending of the first support wall 117 or the second support wall 135 may be prevented or reduced.

According to an embodiment, the deformable portion 120 may include at least one recess 225. When each of the components of the deformable portion 120 is folded or unfolded relative to another component, the at least one recess 225 may prevent or reduce a chance of a portion connected to the other component from being torn. For example, the at least one recess 225 may be defined as a circular recess structure or a circular pivot structure.

According to an embodiment, the at least one recess 225 may be formed to be sunken further in at least a portion of the first deformable part 221 or at least a portion of the second deformable part 223 than the other portion thereof.

FIG. 7A is a cut-away perspective view illustrating an adapter accessory according to an example embodiment.

FIG. 7B is a cross-sectional perspective view illustrating a portion of an adapter accessory according to an example embodiment.

FIG. 7C is a cross-sectional view illustrating an adapter accessory coupled to a case according to an example embodiment.

FIG. 7D is a cross-sectional view illustrating an adapter accessory separated from a case according to an example embodiment.

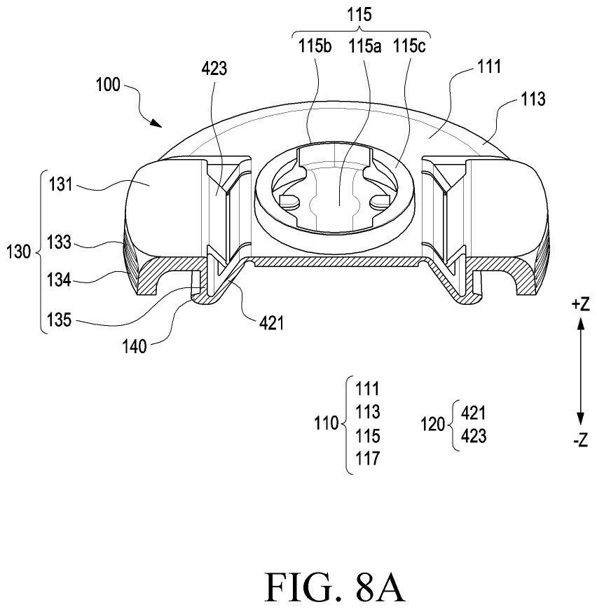

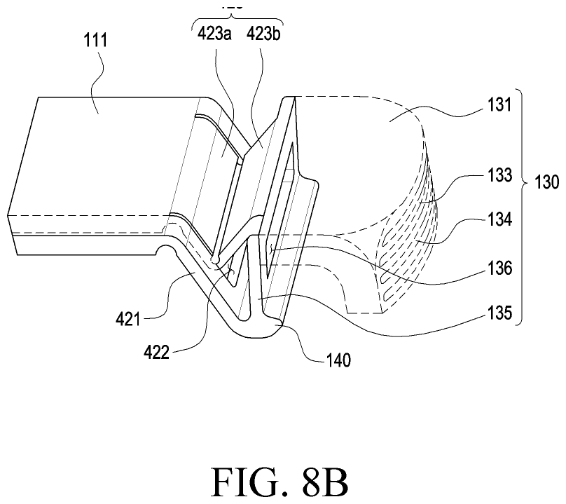

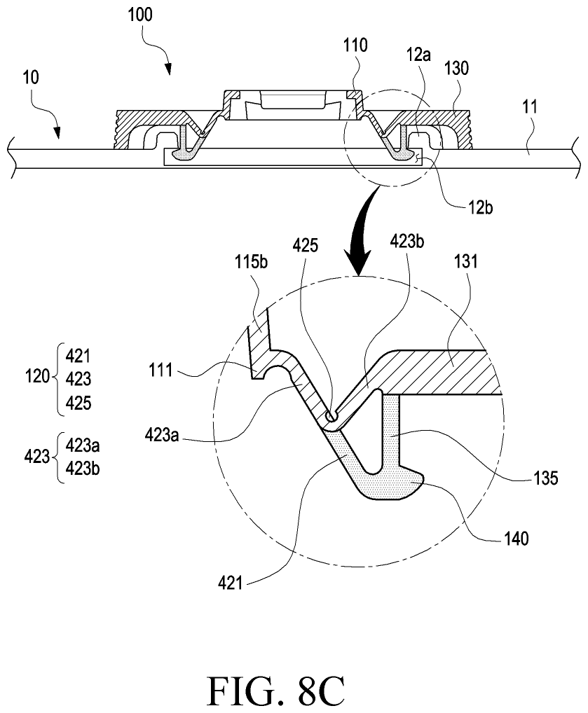

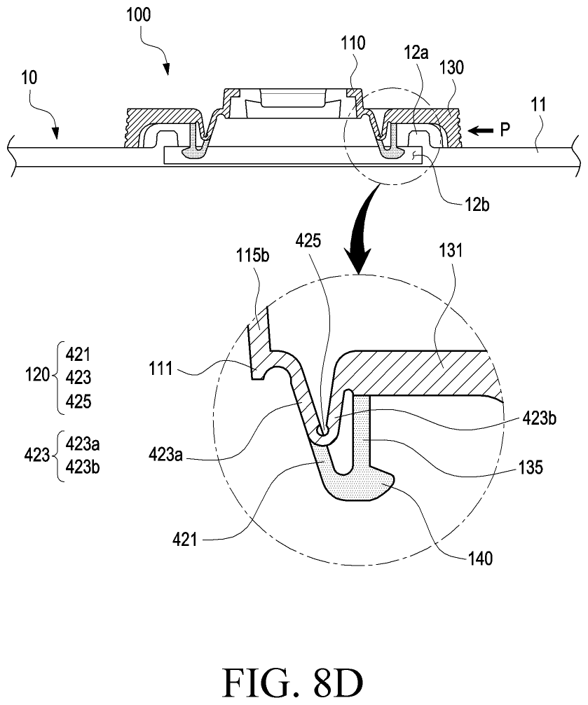

The embodiments of FIGS. 7A to 7D may be combined with the embodiments of FIGS. 1 to 6C or the embodiments of FIGS. 8A to 10B.

According to an embodiment, the deformable portion 120 of the adapter accessory 100 may include a first deformable part 321.

According to an embodiment, the first deformable part 321 may connect the top end (e.g., an end facing the +Z direction in FIG. 7A) of the first support wall 117 and the bottom end (e.g., an end facing the −Z direction in FIG. 7A) of the second support wall 135.

According to an embodiment, the first deformable part 321 may be formed to be at least partially bendable. For example, with respect to a portion of the first deformable part 321 connected to the first support wall 117, the first deformable part 321 may be folded or unfolded relative to the first support wall 117. Further, with respect to a portion of the first deformable part 321 connected to the second support wall 135, the first deformable part 321 may be folded or unfolded relative to the second support wall 135.

According to an embodiment, the first deformable part 321 may include at least one first opening 322 formed to penetrate at least one portion thereof. The first opening 322 may be interpreted as a portion formed by cutting through at least one portion of the first deformable part 321.

According to an embodiment, since the first opening 322 is formed in the first deformable part 321, when the first deformable part 321 is compressively deformed or elastically restored, the first deformable part 321 may be more easily elastically deformed.

While the deformable portion 120 is not compressed (e.g., FIG. 7C), the first support wall 117 and the second support wall 135 may be spaced apart from each other by a first distance L1. While the deformable portion 120 is compressed (e.g., FIG. 7D), the first support wall 117 and the second support wall 135 may be spaced apart from each other by a second distance L2 smaller than the first distance L1. For example, the distance L2 between the first support wall 117 and the second support wall 135 in the compressed state (e.g., FIG. 7D) of the deformable portion 120 may be smaller than the distance L1 between the first support wall 117 and the second support wall 135 in the elastically restored state (e.g., FIG. 7C).

Referring to FIG. 7C, a pair of fixing portions 140 of the adapter accessory 100 may be inserted into the at least one groove 12B of the case 10 of the electronic device. Accordingly, as the pair of fixing portions 140 are fixedly caught in at least a portion of the protrusion 12a of the case 10, the adapter accessory 100 may be prevented from being separated from the case 10.

Referring to FIG. 7D, the deformable portion 120 is shown as compressed. For example, when the user presses the button portion 130 (e.g., the second side portion 135) (e.g., applies a force in the direction P), the deformable portion 120 may be compressed. When the deformable portion 120 is compressed, the first support wall 117 and the second support wall 135 may come closer at the second distance L2.

According to an embodiment, while the deformable portion 120 is compressed, the fixing portion 140 connected to the button portion 130 may be separated from the at least one groove 12b. As illustrated in FIG. 7D, with the fixing portion 140 detached from the at least one groove 12b, the adapter accessory 100 may be separated from the case 10.

In order to couple the adapter accessory 100 to the case 10, the deformable portion 120 may be compressed by pressing the button portion 130, and then the adapter accessory 100 may be seated on the fastening portion 12 of the case 10. Further, when the pressure on the button portion 130 is released with the adapter accessory 100 seated on the fastening portion 12, the deformable portion 120 may be elastically restored, and thus the fixing portion 140 may be inserted into the at least one groove 12b, as illustrated in FIG. 7C.

According to an embodiment, the deformable portion 120 may include at least one recess 325. The at least one recess 325 may prevent or reduce a chance of a portion connected to the first support wall 117 and/or the second support wall 135 from being torn, when the first deformable part 321 of the deformable portion 120 is folded or unfolded relative to the first support wall 117 or the second support wall 135. For example, the at least one recess 325 may be defined as a circular recess structure or a circular pivot structure.

According to an embodiment, the at least one recess 325 may be formed to be sunken further in at least one portion of the first deformable part 321 than in the other portion thereof.

FIG. 8A is a cut-away perspective view illustrating an adapter accessory according to an example embodiment.

FIG. 8B is a cross-sectional perspective view illustrating a portion of an adapter accessory according to an example embodiment.

FIG. 8C is a cross-sectional view illustrating an adapter accessory coupled to a case according to an example embodiment.

FIG. 8D is a cross-sectional view illustrating an adapter accessory separated from a case according to an example embodiment.

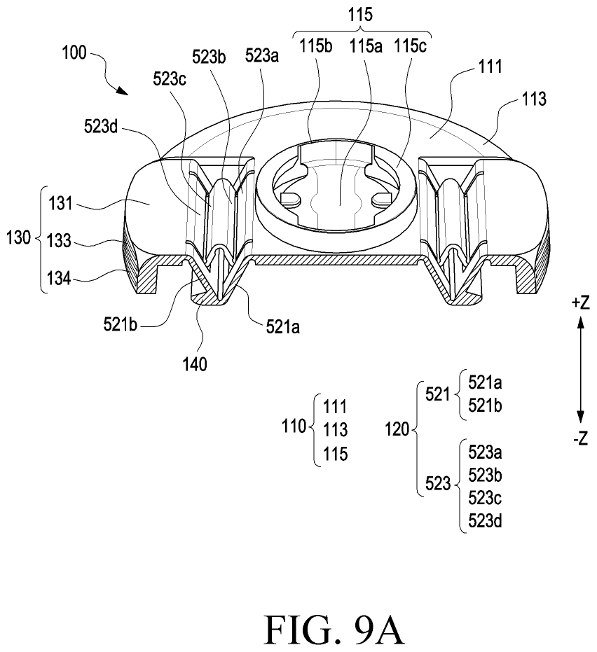

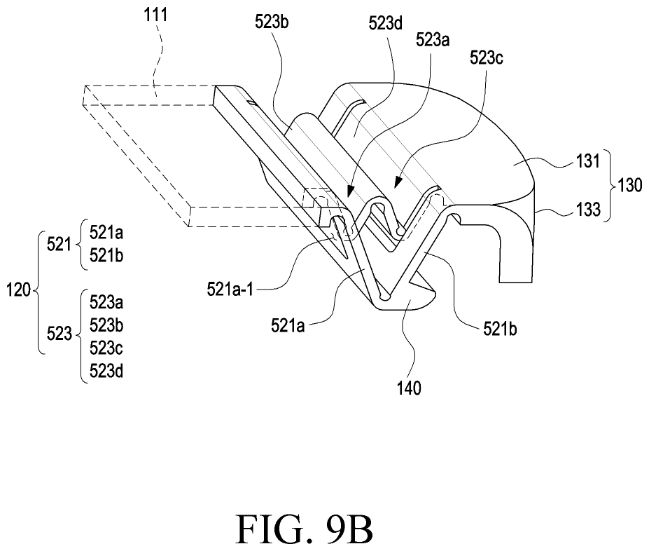

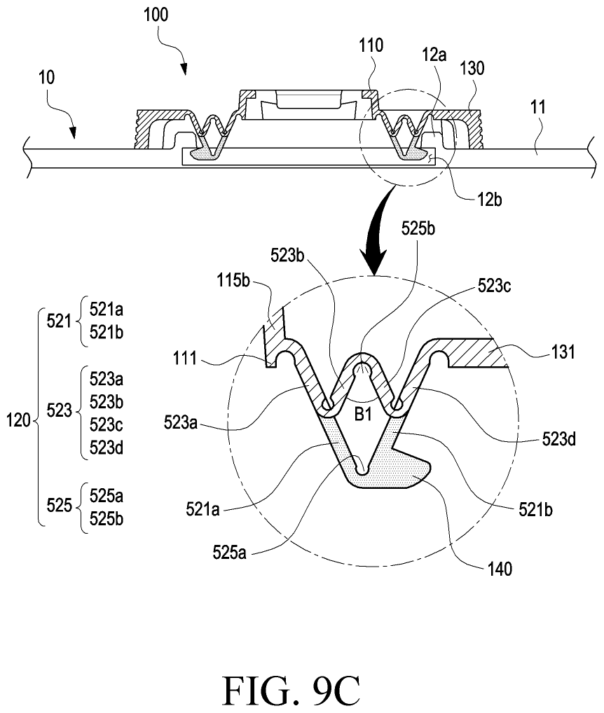

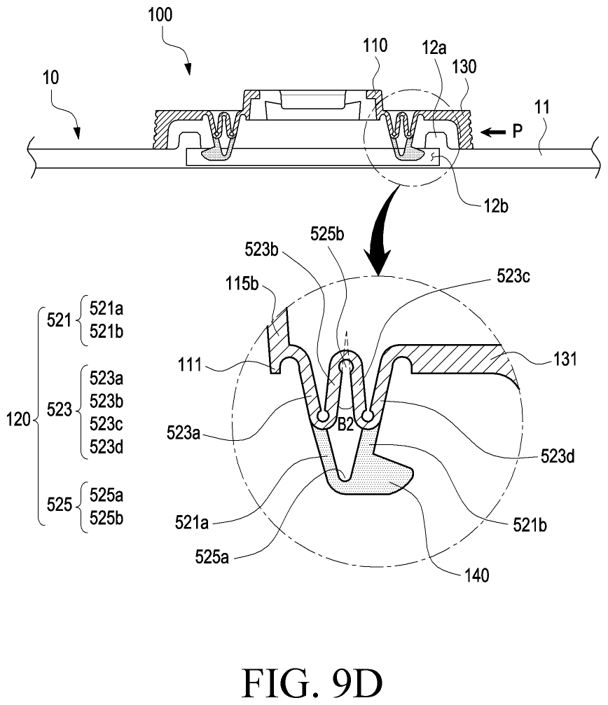

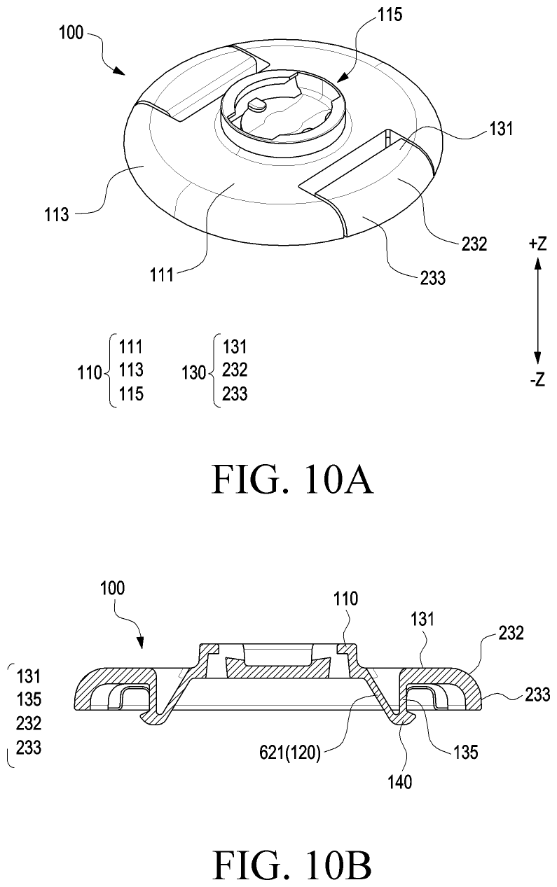

The embodiments of FIGS. 8A to 8D may be combined with the embodiments of FIGS. 1 to 7D or the embodiments of FIGS. 9A to 10B.

According to an embodiment, the deformable portion 120 of the adapter accessory 100 may include a first deformable part 421 or a second deformable part 423.

According to an embodiment, the first deformable part 421 may connect the bottom end (e.g., an end facing the −Z direction in FIG. 8A) of the second support wall 135 and at least a portion of the first flat portion 111.

According to an embodiment, the first deformable part 421 may be formed to be at least partially bendable.

According to an embodiment, the first deformable part 421 may include at least one first opening 422 formed to penetrate at least one portion thereof. The first opening 422 may be interpreted as a portion formed by cutting through at least one portion of the first deformable part 421.

According to an embodiment, when the first opening 422 is formed in the first deformable part 421, the first deformable part 421 may be more easily elastically deformed, when the first deformable part 421 is compressively deformed or elastically restored.

According to an embodiment, at least a portion of the second deformable part 423 may be accommodated in the first opening 422.

According to an embodiment, the second deformable part 423 may include a first inclined part 423a and a second inclined part 423b. The first inclined part 423a may extend from a portion of the first flat portion 111. Further, the first inclined part 423a may extend to be inclined with respect to the first flat portion 111. For example, the first inclined part 423a may be interpreted as extending from a point (or a portion) of the first flat portion 111 toward the bottom end (e.g., an end facing the −Z direction in FIG. 8A) of the second support wall 135.

According to an embodiment, the first inclined part 423a may be connected to the second inclined part 423b.

According to an embodiment, the second inclined part 423b may extend from the top end (e.g., an end facing the +Z direction in FIG. 6A) of the second support wall 135. Further, the second inclined part 423b may be inclined from the second support wall 135 to form an acute angle with respect to the second support wall 135.

According to an embodiment, the second support wall 135 may be formed to have a second opening 136 penetrating at least a portion of the second support wall 135. At least a portion of the second deformable part 423 may be accommodated in the second opening 136.

Referring to FIG. 8C, a pair of fixing portions 140 of the adapter accessory 100 may be inserted into the at least one groove 12b of the case 10 of the electronic device. Accordingly, since the pair of fixed portions 140 are fixedly caught in at least a portion of the protrusion 12a of the case 10, the adapter accessory 100 may be prevented or reduced from being separated from the case 10.

Referring to FIG. 8D, the deformable portion 120 is shown as compressed. For example, when the user presses the button portion 130 (e.g., the second side portion 135) (e.g., applies a force in the direction P), the deformable portion 120 may be compressed. When the deformable portion 120 is compressed, an acute angle formed by the first inclined part 423a and the second inclined part 423b may be reduced. For example, the acute angle formed by the first inclined part 423a and the second inclined part 423b in the compressed state (e.g., FIG. 8D) of the deformable portion 120 may be smaller than the acute angle formed by the first inclined part 423a and the second inclined part 423b in the non-compressed state (e.g., FIG. 8C) of the deformable portion 120.

According to an embodiment, while the deformable portion 120 is compressed, the fixing portion 140 connected to the button portion 130 may be detached from the at least one groove 12b. As illustrated in FIG. 8D, with the fixing portion 140 detached from at least one groove 12b, the adapter accessory 100 may be separated from the case 10.

In order to couple the adapter accessory 100 to the case 10, the deformable portion 120 may be compressed by pressing the button portion 130, and then the adapter accessory 100 may be seated on the fastening portion 12 of the case 10. Further, when the pressure on the button portion 130 is released with the adapter accessory 100 seated on the fastening portion 12, the deformable portion 120 may be elastically restored, and thus the fixing portion 140 may be inserted into the at least one groove 12b, as illustrated in FIG. 8C.

According to an embodiment, the deformable portion 120 may include at least one recess 425. When the first inclined part 423a and the second inclined part 423b are folded or unfolded relative to each other, the at least one recess 425 may prevent or reduce a chance of a portion where the first inclined part 423a and the second inclined part 423b are connected from being torn. For example, the at least one recess 425 may be defined as a circular recess structure or a circular pivot structure.

According to an embodiment, the at least one recess 425 may be formed to be sunken further in at least one portion of the second deformable part 423 than in the other portion thereof.

FIG. 9A is a cut-away perspective view illustrating an adapter accessory according to an example embodiment.

FIG. 9B is a cross-sectional perspective view illustrating a portion of an adapter accessory according to an example embodiment.

FIG. 9C is a cross-sectional view illustrating an adapter accessory coupled to a case according to an example embodiment.

FIG. 9D is a cross-sectional view illustrating an adapter accessory separated from a case according to an example embodiment.

The embodiments of FIGS. 9A to 9D may be combined with the embodiments of FIGS. 1 to 8D or the embodiments of FIGS. 10A and 10B.

According to an embodiment, the deformable portion 120 of the adapter accessory 100 may include a first deformable part 521 or a second deformable part 523.

According to an embodiment, the first deformable part 521 may connect at least a portion of the first flat portion 111 and at least a portion of the second flat portion 131.

According to an embodiment, the first deformable part 521 may be formed to be at least partially bendable.

According to an embodiment, the first deformable part 521 may include a first inclined part 521a and a second inclined part 521b.

The first inclined part 521a may extend from a portion of the first flat portion 111. Further, the first inclined part 521a may extend to be inclined with respect to the first flat portion 111.

According to an embodiment, the first inclined part 521a may be connected to the second inclined part 521b.

The second inclined part 521b may extend from a portion of the second flat portion 131. Further, the second inclined part 521b may extend to be inclined with respect to the second flat portion 131.

According to an embodiment, the second inclined part 521b may be connected to the first inclined part 521b.

According to an embodiment, the first inclined part 521a may include a first opening 521a-1 formed to penetrate at least a portion thereof. The first opening 521a-1 may be interpreted as a portion formed by cutting through at least a portion of the first inclined part 521a.

According to an embodiment, at least a portion of the second deformable part 523 (e.g., a third inclined part 523a or a fourth inclined part 523b) may be accommodated in the first opening 521a-1.

According to an embodiment, the second inclined part 521b may include a second opening 521b-1 formed to penetrate at least a portion thereof. The second opening 521b-1 may be interpreted as a portion formed by cutting through at least a portion of the second inclined part 521b.

According to an embodiment, at least a portion (e.g., a fifth inclined part 523c or a sixth inclined part 523d) of the second deformable part 523 may be accommodated in the second opening 521b-1.

According to an embodiment, since the first opening 521a-1 and the second opening 521b-1 are formed in the first deformable part 521, when the first deformable part 521 is compressively deformed or elastically restored, the first deformable part 521 may be elastically deformed more easily.

According to an embodiment, the second deformable part 523 may include the third inclined part 523a, the fourth inclined part 523b, the fifth inclined part 523c, or the sixth inclined part 523d.

The third inclined part 523a may extend to be inclined from at least a portion of the first flat portion 111. The fourth inclined part 523b may be connected to the third inclined part 523a so as to form an acute angle with respect to the third inclined part 523a.

The fifth inclined part 523c may be connected to the fourth inclined part 523b so as to form an acute angle with respect to the fourth inclined part 523b. The sixth inclined part 523d may be connected to the fifth inclined part 523c so as to form an acute angle with respect to the fifth inclined part 523c. The sixth inclined part 523d may extend to be inclined from at least a portion of the second flat portion 131.

According to an embodiment, the third inclined part 523a, the fourth inclined part 523b, the fifth inclined part 523c, and the sixth inclined part 523d may be connected in, but are not limited to, a ‘W’ shape.

At least a portion of the third inclined part 523a and the fourth inclined part 523b may be accommodated in the first opening 521a-1. At least a portion of the fifth inclined part 523c and the sixth inclined part 523d may be accommodated in the second opening 521b-1.

Referring to FIG. 9C, a pair of fixing portions 140 of the adapter accessory 100 may be inserted into the at least one groove 12b of the case 10 of the electronic device. Accordingly, since the pair of fixed portions 140 are fixedly caught in at least a portion of the protrusion 12a of the case 10, the adapter accessory 100 may be prevented or reduced from being separated from the case 10.

Referring to FIG. 9D, the deformable portion 120 is shown as compressed. For example, when the user presses the button portion 130 (e.g., the second side portion 135) (e.g., applies a force in the direction P), the deformable portion 120 may be compressed. When the deformable portion 120 is compressed, an acute angle B2 formed by the fourth inclined part 523b and the fifth inclined part 523c may be reduced. For example, the acute angle B2 formed by the fourth inclined part 523b and the fifth inclined part 523c may be smaller in the compressed state (e.g., FIG. 9D) of the deformable portion 120 than an acute angle B1 formed by the fourth inclined part 523b and the fifth inclined part 523c in the non-compressed state (e.g., FIG. 9C) of the deformable portion 120.

According to an embodiment, while the deformable portion 120 is compressed, the fixing portion 140 connected to the button portion 130 may be detached from the at least one groove 12b. As illustrated in FIG. 9D, with the fixing portion 140 detached from at least one groove 12b, the adapter accessory 100 may be separated from the case 10.

In order to couple the adapter accessory 100 to the case 10, the deformable portion 120 may be compressed by pressing the button portion 130, and then the adapter accessory 100 may be seated on the fastening portion 12 of the case 10. Further, with the adapter accessory 100 seated on the fastening portion 12, when the pressure on the button portion 130 is released, the deformable portion 120 may be elastically restored, and thus the fixing portion 140 may be inserted into the at least one groove 12b, as illustrated in FIG. 9C.

According to an embodiment, the deformable portion 120 may include at least one recess 525. The at least one recess 525 may include a first recess 525a that prevents or reduces chances of a portion where the first inclined part 523a and the second inclined part 523b are connected from being torn, when the first inclined part 521a and the second inclined part 521b are folded or unfolded relative to each other. For example, the at least one first recess 525a may be defined as a circular recess structure or a circular pivot structure. According to an embodiment, at least one first recess 525a may be formed to be sunken further in at least one portion of the first deformable part 521 than in the other portion thereof.

The at least one recess 525 may include a second recess 525b that prevents a portion connected to another component from being torn, when a component of the second deformable part 523 is folded or unfolded relative to the other component. For example, at least one second recess 525b may be defined as a circular recess structure or a circular pivot structure. In an embodiment, the at least one second recess 525b may be formed to be sunken further in at least one portion of the second deformable part 523 than in the other portion thereof.

FIG. 10A is a perspective view illustrating an adapter accessory according to an example embodiment.

FIG. 10B is a cross-sectional view illustrating an adapter accessory according to an example embodiment.

The embodiments of FIGS. 10A and 10B may be combined with the embodiments of FIGS. 1 to 9D.

Referring to FIGS. 10A and 10B, the adapter accessory 100 (e.g., the adapter accessory 100 of FIGS. 1 and 2) may include the accessory body 110, the deformable portion 120, the button portion 130, or the fixing portion 140.

According to an embodiment, the accessory body 110 may include the first flat portion 111, the first side portion 113, or the coupling portion 115.

According to an embodiment, the button portion 130 may be connected to the deformable portion 120. The button portion 130 may be configured to press the deformable portion 120 by a force applied from the outside or to be pressed by the deformable portion 120.

According to an embodiment, when the user presses the button portion 130, the button portion 130 may slide and compress the deformable portion 120, and when the user releases the pressure on the button portion 130, the button portion 130 may be compressed by the deformable portion 120 and slide.

According to an embodiment, the button portion 130 may include the second flat portion 131, a second side portion 233, a curved portion 232, or the second support wall 135.

According to an embodiment, the curved portion 232 may be a portion connecting an edge of the second flat portion 131 and the second side portion 233. For example, the curved portion 232 may include a curved surface so that the portion where the second flat portion 131 and the second side portion 233 are connected is in a rounded shape.

According to an embodiment, the deformable portion 120 may include a first deformable part 621. The first deformable part 621 may extend from at least a portion of the first flat portion 111. The first deformable part 621 may extend to be inclined with respect to the first flat portion 111. The first deformable part 621 may extend toward the bottom end (e.g., an end facing the −Z direction in FIG. 10A) of the second support wall 135.

An external accessory may be mounted and used on a case of an electronic device to improve usability. To install the external accessory on the case, an adapter device for fixing the external accessory needs to be installed on the case.

Generally, the adapter device may be coupled to the case through an adhesive member such as a double-sided tape. However, when the adapter device is installed on the case through the adhesive member, there is a concern that the adhesive strength of the adhesive member may deteriorate with repeated use, causing the adapter device to be separated from the case.

According to various embodiments of the disclosure, an adapter accessory detachably coupled to a case of an electronic device may be provided.

However, the problems to be solved in the disclosure is not limited to the problem mentioned above, and may be determined in various ways without departing from the spirit and scope of the disclosure.

According to various embodiments of the disclosure, an adapter accessory may be configured to be easily coupled to or decoupled from a case of an electronic device.

The effects obtainable in the disclosure are not limited to the effects mentioned above, and other effects not mentioned may be clearly understood by those skilled in the art from the following description.

According to an example embodiment, the adapter accessory 100 may include the accessory body 110, the deformable portion 120, the button portion 130, or the fixing portion 140. The accessory body 110 may include the coupling portion 115 configured to couple the external accessory 20 thereto. The deformable portion 120 may extend from the accessory body. The deformable portion 120 may be configured to be at least partially deformable by a force applied from an outside. The button portion 130 may be connected to the deformable portion. The button portion 130 may be configured to press the deformable portion by the force applied from the outside or to be pressed by the deformable portion. The fixing portion 140 may be configured to be coupled, directly or indirectly, to the external case 10. The fixing portion 140 may be formed to protrude from at least a portion of the button portion. A material of the deformable portion may be the same as a material of the button portion.

According to an embodiment, the accessory body may further include the first flat portion 111, the first side portion 113, or the first support wall 117. The first flat portion 111 may have a circular shape. The first side portion 113 may extend from an edge of the first flat portion. The first support wall 117 may be formed to protrude from at least a portion of the first flat portion.

According to an embodiment, the first support wall may be disposed inside the first side portion.

According to an embodiment, the button portion may include the second flat portion 131 or the second side portion 133. The second side portion 133 may extend from an edge of the second flat portion.

According to an embodiment, the pattern portion 134 including at least one slit may be formed on a surface of the second side portion.

According to an embodiment, the deformable portion may be formed to be at least partially bendable.

According to an embodiment, the deformable portion may include the first deformable part 121 or the second deformable part 123. The first deformable part 121 may extend from a portion of the accessory body to a portion of the button portion. The second deformable part 123 may extend from another portion of the accessory body to another portion of the button portion.

According to an embodiment, the first deformable part may include the first inclined part 121a or the second inclined part 121b. The second inclined part 121b may be obliquely connected to the first inclined part. The second deformable part may include the third inclined part 123a or the fourth inclined part 123b. The fourth inclined part 123b may be obliquely connected to the third inclined part.

According to an embodiment, a portion where the first inclined part 121a and the second inclined part 121b are connected may be disposed to face a portion where the third inclined part 123a and the fourth inclined part 123b are connected.

According to an embodiment, a portion where the first inclined part 221a and the second inclined part 221b are connected may be disposed to face an opposite direction to a portion where the third inclined part 223a and the fourth inclined part 223b are connected.

According to an embodiment, the deformable portion may include the first deformable part 321 or the first opening 322. The first deformable part 321 may extend from a portion of the accessory body to a portion of the button portion. The first opening 322 may be formed to penetrate at least a portion of the first deformable part.

According to an embodiment, the deformable portion may include the first deformable part 421, the second deformable part 423, or the first opening 422. The first deformable part 421 may extend from a portion of the accessory body to a portion of the button portion. The second deformable part 423 may extend from another portion of the accessory body to the portion of the button portion. The first opening 422 may be formed in at least a portion of the first deformable part.

According to an embodiment, the second deformable part may include the first inclined part 423a or the second inclined part 423b. The second inclined part may be obliquely connected to the first inclined part. At least a portion of the first inclined part may be accommodated in the first opening.

According to an embodiment, the deformable portion may include the first deformable part 521 or the second deformable part 523. The first deformable part 521 may extend from a portion of the accessory body to a portion of the button portion. The second deformable part 523 may extend from another portion of the accessory body to the portion of the button portion. The first deformable part may include the first inclined part 521a or the second inclined part 521b. The first inclined part 521a may include the first opening 521a-1. The second inclined part 521b may be obliquely connected to the first inclined part. The second inclined part 521b may include the second opening 521b-1.

According to an embodiment, the second deformable part may be at least partially accommodated in the first opening or the second opening.

According to an embodiment, the fixing portion may include the inclined surface 140a. The inclined surface 140a may form an obtuse angle with respect to the button portion to which the fixing portion is connected.

According to an example embodiment, the adapter accessory 100 may include the accessory body 110, the deformable portion 120, the button portion 130, or the fixing portion 140. The accessory body 110 may be configured to be coupled to the external accessory 20. The deformable portion 120 may extend from the accessory body. The deformable portion 120 may be configured to be at least partially deformable by a force applied from an outside. The button portion 130 may be connected to the deformable portion. The button portion 130 may press the deformable portion by the force applied from the outside or be pressed by the deformable portion. The fixing portion 140 may be configured to be coupled to an external case. The fixing portion 140 may be formed to protrude from at least a portion of the button portion. The accessory body, the deformable portion, the button portion, and the fixing portion may be formed integrally.

According to an embodiment, the accessory body may further include the first flat portion 111, the first side portion 113, or the first support wall 117. The first flat part 111 may have a circular shape. The first side portion 113 may extend from an edge of the first flat portion. The first support wall 117 may be formed to protrude from at least a portion of the first flat portion.

According to an embodiment, the button portion may include the second flat portion 131 or the second side portion 133. The second side portion 133 may extend from an edge of the second flat portion.

According to an embodiment, the pattern portion 134 including at least one slit may be formed on a surface of the second side portion.

While specific embodiments have been described in the detailed description of the disclosure, it will be apparent to those skilled in the art that many modifications may be made within the scope of the disclosure.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An adapter accessory comprising:
an accessory body including a coupling portion configured to couple an external accessory thereto;
a deformable portion, comprising flexible material, extending from the accessory body and configured to be at least partially deformable by a force applied from an outside;
a button portion connected to the deformable portion and configured to press the deformable portion due to the force applied from the outside and/or to be pressed by the deformable portion; and
a fixing portion, comprising a protrusion, configured to be coupled to an external case and formed to protrude from at least part of the button portion,
wherein a material of the deformable portion is the same as a material of the button portion.

2. The adapter accessory of claim 1, wherein the accessory body further includes:
a first flat portion having a circular shape;
a first side portion extending from an edge of the first flat portion; and
a first support wall formed to protrude from at least of the first flat portion.

3. The adapter accessory of claim 2, wherein the first support wall is disposed inside the first side portion.

4. The adapter accessory of claim 1, wherein the button portion includes:
a second flat portion; and
a second side portion extending from an edge of the second flat portion.

5. The adapter accessory of claim 4, wherein a pattern portion including at least one slit is formed on a surface of the second side portion.

6. The adapter accessory of claim 1, wherein the deformable portion is configured to be at least partially bendable.

7. The adapter accessory of claim 1, wherein the deformable portion includes:
a first deformable part extending from a portion of the accessory body to a portion of the button portion; and
a second deformable part extending from another portion of the accessory body to another portion of the button portion.

8. The adapter accessory of claim 7, wherein the first deformable part includes a first inclined part and a second inclined part obliquely connected to the first inclined part, and
wherein the second deformable part includes a third inclined part and a fourth inclined part obliquely connected to the third inclined part.

9. The adapter accessory of claim 8, wherein a portion where the first inclined part and the second inclined part are connected is disposed to face a portion where the third inclined part and the fourth inclined part are connected, respectively.

10. The adapter accessory of claim 8, wherein a portion where the first inclined part and the second inclined part are connected is disposed to face an opposite direction to a portion where the third inclined part and the fourth inclined part are connected, respectively.

11. The adapter accessory of claim 1, wherein the deformable portion includes:
a first deformable part extending from a portion of the accessory body to a portion of the button portion; and
a first opening formed to penetrate at least a portion of the first deformable part.

12. The adapter accessory of claim 1, wherein the deformable portion includes:
a first deformable part extending from a portion of the accessory body to a portion of the button portion;
a second deformable part extending from another portion of the accessory body to the portion of the button portion; and
a first opening formed in at least a portion of the first deformable part.

13. The adapter accessory of claim 12, wherein the second deformable part includes a first inclined part and a second inclined part obliquely connected to the first inclined part, and
wherein at least a portion of the first inclined part is accommodated in the first opening.

14. The adapter accessory of claim 1, wherein the deformable portion includes:
a first deformable part extending from a portion of the accessory body to a portion of the button portion; and
a second deformable part extending from another portion of the accessory body to the portion of the button portion, and
wherein the first deformable part includes a first inclined part including a first opening and a second inclined part obliquely connected to the first inclined part and including a second opening.

15. The adapter accessory of claim 14, wherein the second deformable part is at least partially accommodated in the first opening or the second opening.

16. The adapter accessory of claim 1, wherein the fixing portion includes an inclined surface forming an obtuse angel with the button portion connected to the fixing member.

17. An adapter accessory comprising:
an accessory body including a coupling portion configured to couple an external accessory thereto;
a deformable portion, comprising flexible material, extending from the accessory body and configured to be at least partially deformable by a force applied from an outside;
a button portion connected to the deformable portion and configured to press the deformable portion due to the force applied from the outside and/or to be pressed by the deformable portion; and
a fixing portion, comprising a protrusion, configured to be coupled to an external case and formed to protrude from at least of the button portion,
wherein the accessory body, the deformable portion, the button portion and the fixing portion are formed as a single piece.

18. The adapter accessory of claim 17, wherein the accessory body further comprises;
a first flat portion having a circular shape;
a first side portion extending from an edge of the first flat portion; and
a first support wall formed to protrude from at least of the first flat portion.

19. The adapter accessory of claim 17, wherein the button portion includes:
a second flat portion; and
a second side portion extending from an edge of the second flat portion.

20. The adapter accessory of claim 19, wherein a pattern portion including at least one slit is formed on a surface of the second side portion.
